(19) United States
(12) Patent Application Publication
(10) Pub. No.: US 2025/0069187 A1
(43) Pub. Date: Feb. 27, 2025

(54) IMAGE SIGNAL PROCESSOR

(71) Applicant: SK hynix Inc., Gyeonggi-do (KR)

(72) Inventor: Kazuhiro YAHATA, Tokyo (JP)

(21) Appl. No.: 18/402,730

(22) Filed: Jan. 3, 2024

(30) Foreign Application Priority Data
Aug. 25, 2023 (KR) 10-2023-0111819

(51) Int. Cl. G06T 3/4038; G06V 10/75

(52) U.S. Cl. CPC G06T 3/4038; G06V 10/758

(57) ABSTRACT

An image signal processor includes a bit extension processor configured to generate extension data by expanding, by a first number of bits, a number of bits of input data including a Bayer image and a white image, and an output circuit configured to adjust, upon receiving the extension data, the first number of bits to a second number of bits, to generate output data.

### CROSS-REFERENCE TO RELATED APPLICATION

This application claims priority under 35 U.S.C. § 119 to, and the benefits of, Korean patent application No. 10-2023-0111819, filed on Aug. 25, 2023, which is herein incorporated by reference in its entirety.

### TECHNICAL FIELD

The technology and implementations disclosed in the present disclosure generally relate to an image signal processor capable of processing image signals.

### BACKGROUND

Recently, as the number of functions of electronic devices rapidly increases, demand for improving an image capture function using such electronic devices is also increasing. Accordingly, technology for improving a quality of images obtained through the electronic devices is desired.

An image sensor used in an imaging device has a configuration in which color filters that respectively transmit red (R) light, green (G) light, and blue (B) light of a specific wavelength band for each pixel are attached to a surface of the sensor. There are various types of color arrays for color filters which have been widely used, for example, Bayer arrays, which include three types of filters that transmit only light of specific wavelengths, such as red, green, and blue.

Recently, as pixels of the image sensor are miniaturized in size, the amount of light incident upon each pixel is reduced, increasing a signal-to-noise ratio (SNR), thus causing performance of the image sensor to rapidly deteriorate. In order to increase light transmittance of filters located inside the pixels and realize high-sensitivity pixels in response to the low-illuminance environment, utilization of an image sensor, which includes white (W) filters as well as other filters that transmit only light of specific wavelengths such as red, green, and blue (RGB), is rapidly increasing.

### SUMMARY

Various embodiments of the disclosed technology relate to an image signal processor that enables a rounding error to be smaller than random noise in a process of generating a Bayer image having less noise from images including white pixels, and thus reduces the degree of tone jump and the degree of discoloration.

In accordance with an embodiment of the disclosed technology, an image signal processor may include a bit extension processor configured to generate extension data by expanding, by a first number of bits, a number of bits of input data including a Bayer image and a white image; and an output circuit configured to adjust, upon receiving the extension data, the first number of bits to a second number of bits to generate output data.

In accordance with another embodiment of the disclosed technology, an image signal processor may include a bit extension processor configured to generate extension data by expanding a number of bits of input data by a first number of bits; a storage circuit configured to determine, based on a gain of the input data, a register value for calculating an amount of noise; a number-of-output-bits determiner configured to adjust the first number of bits to a second number of bits based on the register value; and an output circuit configured to generate output data based on the extension data and the second number of bits.

In accordance with another embodiment of the disclosed technology, an image signal processor may include a bit extension processor configured to generate extension data by expanding a number of bits of input data; a storage circuit configured to determine, based on a gain of the input data, a register value for calculating an amount of noise; a dark-region noise measurement circuit configured to measure a dark-region noise of the input data; a number-of-output-bits determiner configured to determine a number of output bits based on the register value and the dark-region noise; and an output circuit configured to receive the extension data and the number of output bits to generate output data having a different number of bits from the extension data.

It is to be understood that both the foregoing general description and the following detailed description of the disclosed technology are illustrative and descriptive and are intended to provide further description of the embodiments of the present disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an imaging device based on one embodiment of the disclosed technology.

FIG. 2 is a schematic diagram illustrating an operation of a bit extension processor of FIG. 1 based on some implementations of the disclosed technology.

FIG. 3 is a schematic diagram illustrating the bit extension processor of FIG. 1 based on some implementations of the disclosed technology.

FIG. 4 is a block diagram illustrating an imaging device based on another embodiment of the disclosed technology.

FIG. 5 is a block diagram illustrating an imaging device based on still another embodiment of the disclosed technology.

FIG. 6 is a flowchart illustrating an image signal processing method based on still another embodiment of the disclosed technology.

FIG. 7 is a block diagram illustrating an example of a computing device corresponding to the image signal processor of FIG. 1 based on some implementations of the disclosed technology.

### DETAILED DESCRIPTION

Embodiments of the present disclosure provide implementations and illustrations of an image signal processor for processing image signals that may be used in configurations to substantially address one or more technical or engineering issues and to mitigate limitations or disadvantages encountered in some image signal processors in the art. Some implementations of the disclosed technology relate to an image signal processor that enables a rounding error to be smaller than random noise in a process of generating a Bayer image having less noise from images including white pixels, and thus reduces the degree of tone jump and the degree of discoloration. In recognition of the issues above, the image signal processor based on some implementations of the disclosed technology can reduce the degree of tone jump and discoloration during remosaic processing of RGBW patterns, thereby improving the quality of image signals.

Reference will now be made in detail to some embodiments of the disclosed technology, which are illustrated in the accompanying drawings. Wherever possible, the same reference numbers will be used throughout the drawings to refer to the same or like parts. While the present disclosure is susceptible to various modifications and alternative forms, specific embodiments thereof are shown in the drawings. However, the present disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

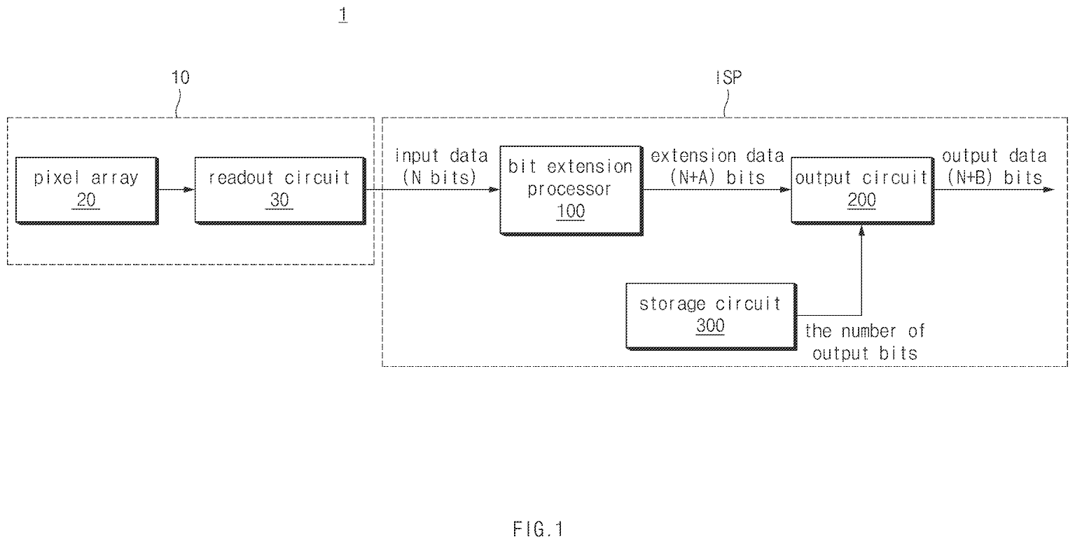

FIG. 1 is a block diagram illustrating an imaging device including a readout circuit based on some implementations of the disclosed technology.

Referring to FIG. 1, the imaging device 1 may include an image sensing device 10 and an image signal processor ISP.

Here, the image sensing device 10 may be or include a complementary metal oxide semiconductor image sensor (CIS) for converting an optical signal into an electrical signal. The image sensing device 10 may control overall operations such as on/off, operation mode, operation timing, sensitivity, etc. by a timing controller (not shown).

The image sensing device 10 may include a pixel array 20 and a readout circuit 30.

The pixel array 20 may include a plurality of pixels consecutively arranged in a two-dimensional (2D) matrix structure (e.g., continuously arranged in row and column directions). Each of the plurality of pixels of the pixel array 20 may generate a pixel signal obtained by converting an optical signal into an electrical signal and output the converted pixel signal to the readout circuit 30.

The readout circuit 30 may process an analog pixel signal output from each of the pixels and generate digital data corresponding to the pixel signal. For example, the readout circuit 30 may include an analog-to-digital converter (ADC) for performing ADC conversion of such pixel signal.

The image signal processor ISP may perform image processing of the image data received from the readout circuit 30. The image signal processor 200 may reduce noise of image data, and may perform various types of image signal processing (e.g., gamma correction, color filter array interpolation, color matrix, color correction, color enhancement, lens distortion correction, etc.) for image-quality improvement of the image data. In addition, the image signal processor ISP may compress image data that has been created by execution of image signal processing for image-quality improvement, such that the image signal processor ISP can create an image file using the compressed image data. Alternatively, the image signal processor 200 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created. For example, the image files may be created according to Exchangeable image file format (Exif) standards.

Image data transferred from the image sensing device 10 to the image signal processor ISP may be a RGBW (Red, Green, Blue, White) pattern in which a Bayer image and a white image are mixed. The image signal processor ISP may perform signal processing to generate a noise-reduced Bayer image using a white image in an RGBW pattern that includes the Bayer image and the white image.

This image signal processor ISP may include a bit extension processor 100, an output circuit 200, and a storage circuit 300.

Here, the bit extension processor 100 may output extension data by expanding the number of bits of input data such that the extension data represents a value including a decimal part. That is, the bit extension processor 100 may obtain a value of extension data, the number of which has been extended to represent the value including a decimal part, and thus the number of bits of extension data may become greater than the number of bits of the input data. For example, when the input data is N bits, where N may be an integer greater than zero ‘0’, e.g., N=10, the bit extension processor 100 may extend the number of bits of the input data to generate the extension data representing the value including a decimal part and may output, instead of the input data, the extension data having (N+A) bits (e.g., (10+A) bits). Here, the A bits may represent a decimal part of the extension data and may be one or more least significant bits (LSBs) of the extension data.

When image capture (i.e., imaging) is performed with high gain in a relatively dark low-illuminance environment, random noise may increase and a standard deviation of noise may further increase after remosaic processing of the capture image. In addition, when the number of output bits is extended, the amount of information transmitted from the image signal processor ISP may increase.

Accordingly, the output circuit 200 may output the number of output bits without change or may output a lesser number of output bits by limiting the number of output bits. That is, the output circuit 200 may receive the extension data and may generate output data based on the number of output bits read from the storage circuit 300. Here, the number of output bits may represent the number of bits corresponding to the decimal part that is supposed to be included in the output data. The number of output bits may be set to an arbitrary number, which does not create false colors in response to the amount of noise to be generated after remosaic processing and prevents the amount of transmission information from excessively increasing.

For example, the output circuit 200 may adjust the value ‘A’ of the extension data having (N+A) bits (e.g., (10+A) bits) to the value ‘B’ (where B may be less than or equal to A) based on the number of output bits provided from the storage circuit 300, and may thus output data having (N+B) bits (e.g., (10+B) bits). Accordingly, under the low-illuminance environment, the image signal processor ISP may prevent, by limiting the number of output bits without extension, the increase in the amount of data caused by meaningless bits of increased random noise.

To adjust the number of bits of the output data, the storage circuit 300 may preset and store the number of output bits corresponding to a gain value of pixel data. The image signal processor ISP may perform a digital operation to calculate a gain of pixel data during the remosaic operation. For example, the image signal processor ISP may perform various operations by adding the gain to pixel data during image signal processing (e.g., noise reduction, white balance adjustment, demosaicing, color correction, gamma correction, color change, etc.)

Since the amount of noise generated after remosaic processing changes depending on the amount of noise in the input data, the number of output bits may vary depending on the amount of noise in the input data. The amount of noise in the input data may mainly depend on the gain (sensitivity) setting of the image sensing device 10.

Accordingly, the image signal processor ISP may determine the relationship between the gain value and the number of output bits in advance, may designate the number of output bits based on the determined relationship, and may store the designated number of output bits in the storage circuit 300. Here, the relationship between the gain value and the number of output bits may be obtained by performing pixel data processing in advance and converting the processed result into data.

As an example, the storage circuit 300 may include a register. The image signal processor ISP may investigate the relationship between the gain of pixel data and the number of output bits in advance, and may implement the investigated relationship information in software. In addition, the storage circuit 300 may store the preset number of output bits in the register when the software is executed in the image signal processor ISP (or a CPU (Central Processing Unit) located inside or outside the ISP).

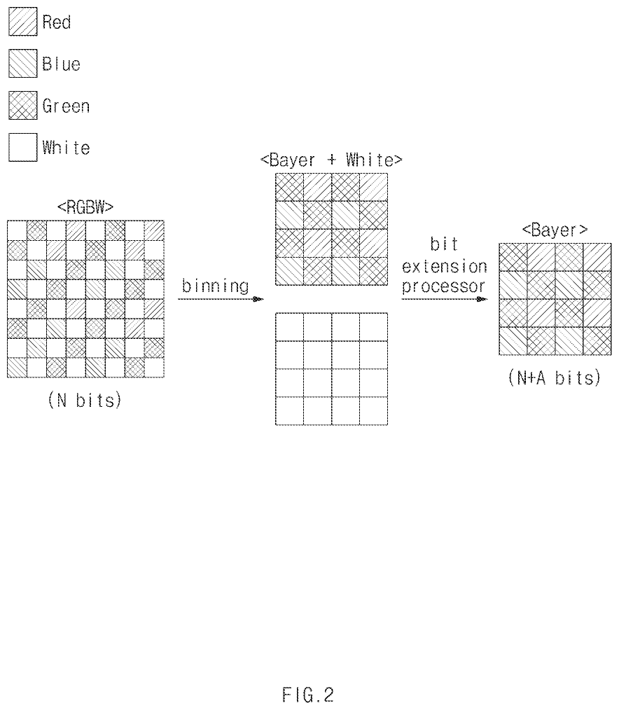

FIG. 2 is a schematic diagram illustrating an operation of the bit extension processor 100 of FIG. 1 based on some implementations of the disclosed technology.

Referring to FIG. 2, input data to be applied to the bit extension processor 100 may be an RGBW pattern in which a Bayer image and a white image are mixed. The RGBW pattern may include color pixels of red (R), blue (B), and green (G) pixels, and white pixels.

Each of the color pixels (R, G, and B pixels) may be a pixel upon which light of a specific wavelength is incident by a corresponding color filter. In addition, the white pixel (W) may be a pixel having no color filters, and may be referred to as a texture pixel, a black-and-white pixel, or a monopixel. For example, the color pixels (R, G, B) may obtain color pixel values according to incident light of a specific color (e.g., red, green, blue, etc.) by a color filter that transmits only incident light of a specific wavelength. In contrast, the white pixel W may obtain a white pixel value according to incident light (e.g., visible light) that is not limited to a specific color.

In the embodiment of FIG. 2, although the RGBW pattern having the size of 64 pixels arranged in an (8×8) matrix has been described for convenience of description, the size of the RGBW pattern and the arrangement shape of the respective pixels are not limited thereto.

When the pixels of the image sensing device 10 are miniaturized, the amount of incident light for each pixel is reduced, resulting in a reduced signal-to-noise ratio (SNR), which will cause performance of the image sensing device 10 to rapidly deteriorate. In order to increase light transmittance of each filter and realize high-sensitivity pixels in response to the low-illuminance environment, the utilization of the image sensing device 10 including white pixels as well as color filters (e.g., RGB filters) designed to transmit only light having a specific wavelength such as red, green, and blue (RGB) is rapidly increasing.

The white image may have relatively strong signal-to-noise ratio (SNR) characteristics compared to RGB images. Since the white image is designed to receive light of a full band as compared to RGB images receiving light of a specific band, the white image may have a relatively low SNR even when acquired in the low-illuminance environment.

The bit extension processor 100 may separate the Bayer image and the white image from each other by binning the RGBW pattern. Here, “binning” may mean summation of pixel values of the unit pixels having the same color on a sub-pixel array (SP) basis. For example, the bit extension processor 100 may sum (e.g., 4-summation) the pixel values of the unit pixels having the same color in the RGBW pattern in units of four (2×2) sub-pixels (i.e., on a sub-pixel basis), resulting in formation of the Bayer image and the white image.

The image signal processor ISP may output an image having good SNR by performing remosaic processing using the white image. In particular, when a high gain is applied to the image under the low-illuminance environment, the resultant image with superior SNR can be output.

The RGBW pattern may be a single-plate image sensor in which R, G, B, and W filters are arranged in a mosaic shape. Therefore, when generating the color image, it is necessary to perform remosaic processing as color coding to generate RGB pixel values corresponding to each pixel.

Here, “remosaic processing” may be a task of outputting a high-quality image signal using pixel signals. Alternatively, “remosaic processing” may mean image processing that converts an original image into an image with a Bayer pattern.

The bit extension processor 100 may perform remosaic processing on the original image using a remosaic method, resulting in formation of a converted image. In some implementations, the remosaic method may be implemented as a method of performing remosaic processing based on a preset reference equation. The reference equation may be an equation for calculating the pixel value of each pixel included in the image on which remosaic processing has been performed. For example, the reference equation may be an equation that calculates pixel values of the remosaic-processed image obtained when weights are applied to pixel values of adjacent pixels in the original image.

In some implementations, the bit extension processor 100 may include a remosaic processing module (not shown) to perform remosaic processing. Here, the configuration of the remosaic processing module may be implemented as a software block to be executed by a predetermined processor or may be implemented as a combination of a dedicated hardware block and a processing unit.

In general, the image signal processor ISP may convert the RGBW pattern into a Bayer pattern by performing various types of signal processing on the RGBW pattern during the remosaic processing. For example, during the remosaic processing, a digital calculation operation of multiplying pixel data by a gain may be performed. Here, quantization errors may be accumulated, which may cause a difference in color sense between images. Accordingly, in order to reduce noise and rapidly perform arithmetic calculation when remosacing the RGBW pattern, the image signal processor ISP may round off a decimal part from among bits of the pixel data value without expressing the decimal part, or may limit the decimal part to a preset limited number of digits.

However, when image capture is performed with a low gain under the relatively bright high-illuminance environment, the standard deviation of random noise becomes less than a specific value, such that the effect of rounding error may be greater than the effect of random noise. For example, if the amount of random noise becomes less than the least significant bit (LSB) “1” after remosaic processing, the effect of rounding errors may increase and false colors may occur. Accordingly, when rounding is performed during the remosaic processing, tone jump or discoloration, etc. may occur in the output image due to the effect of such rounding error.

Accordingly, the bit extension processor 100 based on some implementations of the disclosed technology may extend a number of bits, which represents the pixel value of the Bayer image, to have the decimal part during the remosaic processing and therefore may extend the number of bits from the number of bits of the input data to output the extension data having the extended number of bits. For example, when the number of bits of the input data to be input to the bit extension processor 100 is N, but the number of bits of the extension data to be finally output from the bit extension processor 100 after remosaic processing may be extended to the (N+A) bits. Accordingly, the image signal processor ISP based on some implementations of the disclosed technology can prevent tone jump or discoloration from occurring in the output image by making the rounding error smaller than random noise.

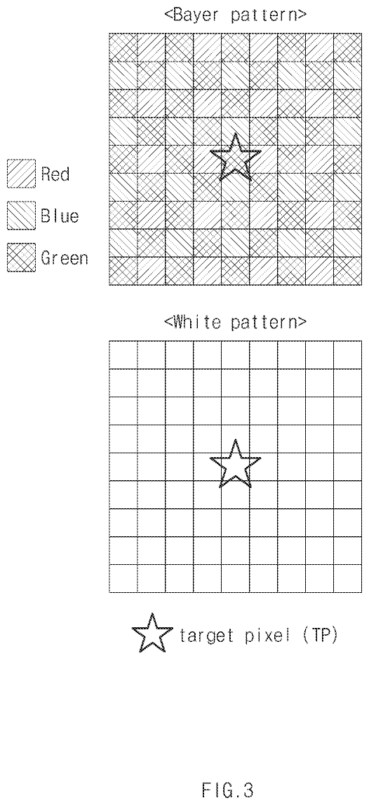

FIG. 3 is a schematic diagram illustrating the bit extension processor 100 of FIG. 1 based on some implementations of the disclosed technology.

A specific method of extending the bits by the bit extension processor 100 will herein be described with reference to FIG. 3.

FIG. 3 illustrates pixels to be used by the bit extension processor 100 that performs bit extension processing. For example, a Bayer pattern with a size of 81 pixels arranged in a (9×9) matrix and a white pattern with a size of 81 pixels arranged in a (9×9) matrix will hereinafter be described as an example.

In the embodiment of FIG. 3, although each of the Bayer pattern and the white pattern has the size of 81 pixels arranged in a (9×9) matrix for convenience of description, the sizes of the Bayer pattern and the white pattern and the arrangement shape of such pixels are not limited thereto.

In the Bayer pattern, bit extension processing may be performed using pixels of the same color as the target pixel (TP) among (9×9) pixels on the basis of the target pixel (TP) to be processed in the Bayer pattern. In the Bayer pattern, the target pixel (TP) may be a green pixel. The Bayer pattern may include 41 green pixels as well as the target pixel (TP). To reduce noise during the remosaic processing, 41 white pixels located at the same position as the green pixels can also be used.

First, the bit extension processor 100 may calculate the statistics value (r) for pixels required to perform bit extension processing as represented by the following equation 1. In some implementations, the statistics value (r) may be calculated with 1 bit indicating the integer part and 13 bits indicating the decimal part.

$$r = \frac{{\sum }_{i = 1}^{41} {S}_{i} {G}_{i}}{{\sum }_{i = 1}^{41} {S}_{i} {W}_{i}} \qquad [ Equation 1 ]$$

In Equation 1, the statistics value (r) may be calculated by expressing a pixel value of the selected green pixel as ‘Gi’ and a pixel value of the selected white pixel as ‘Wi’.

A similarity index (Si) between the target pixel (TP) to be processed and the selected pixels may be calculated as denoted by the following equation 2.

$${S}_{i} = 1 - exp [ - \frac{{( {G}_{i} - {G}_{c} )}^{2} + {( {W}_{i} - {W}_{c} )}^{2}}{V ( {G}_{c} , {W}_{c} )} ] \qquad [ Equation 2 ]$$

In Equation 2, the similarity index (Si) may be calculated using the pixel value of the green pixel to be processed as ‘Gc’ and the pixel value of the white pixel to be processed as ‘Wc’. As the similarity between the pixel value (Gc) of the green pixel and the pixel value (Wc) of the white pixel increases, the similarity index (Si) becomes greater.

In Equation 2, an estimated value V(Gc,Wc) of a noise variance value of the pixels to be processed can be calculated as in Equation 3 below.

$$V ( {G}_{c} , {W}_{c} ) = k ( {G}_{c} + {W}_{c} ) + V 0 \qquad [ Equation 3 ]$$

In Equation 3, ‘k’ is a parameter related to the amount of shot noise. The higher the gain (sensitivity) during shooting (image capture), the higher the estimated value V(Gc, Wc) of the noise variance value. In addition, ‘V₀’ may represent the noise variance value of the image sensing device 10 when light is blocked.

Thereafter, the bit extension processor 100 may calculate a weighted average value (Z) of the white pixels as represented by Equation 4 below.

$$Z = \frac{{\sum }_{i = 1}^{5} {S}_{i} {W}_{i}}{{\sum }_{i = 1}^{5} {S}_{i}} \qquad [ Equation 4 ]$$

In Equation 4, the weighted average value (Z) of the white pixels may be calculated based on the pixel value (Wi) of a total of 5 selected white pixels that include the target pixel (TP) to be processed and four pixels located at upper, lower, left, and right sides from the target pixel (TP). In some implementations, the weighted average value (Z) may be set to 10 bits indicating the integer part and 2 bits indicating the decimal part.

Although the similarity index (Si) is used to calculate the weighted average value (Z) as represented by Equation 4, the method of calculating the weighted average value (Z) based on some implementations of the disclosed technology is not limited thereto. In some other implementations, edge determination may be performed and pixel values may be averaged in the edge direction, so that a weighted average value can be obtained.

In addition, the pixel value (Gout) to be obtained after remosaic processing can be calculated as shown in Equation 5 below.

$${G}_{out} = r Z \qquad [ Equation 5 ]$$

In Equation 5, the pixel value (Gₒᵤₜ) may be obtained based on the statistics value (r) calculated by Equation 1 and the weighted average value (Z) calculated by Equation 4. Here, the statistics value (r) may include 1 bit indicating the integer part and 13 bits indicating the decimal part, and the weighted average value (Z) may include 10 bits indicating the integer part and 2 bits indicating the decimal part. In this case, the value ‘rZ’ may include 11 bits indicating the integer part and 15 bits indicating the decimal part. For example, under high-illumination and minimum-sensitivity conditions, if random noise generated after remosaic processing is reduced to about ⅛, about 4 bits are required to represent the decimal part and more bits than 4 bits are unnecessary in order to sufficiently reduce the rounding error and prevent pseudo colors. Therefore, among a total of 15 bits, the decimal part can be represented by upper 4 bits and the remaining 11 bits other than the upper 4 bits may be unnecessary and may be discarded. If the most significant bit (MSB) of the integer part is denoted by “1”, that is, if the number of bits corresponding to the integer part exceeds 1023, this integer part can be clipped to 1023. As a result, a total of 14 bits can be obtained by summing 10 bits of the integer part and 4 bits of the decimal part, and the pixel value (Gₒᵤₜ) may be an integer of 14 bits.

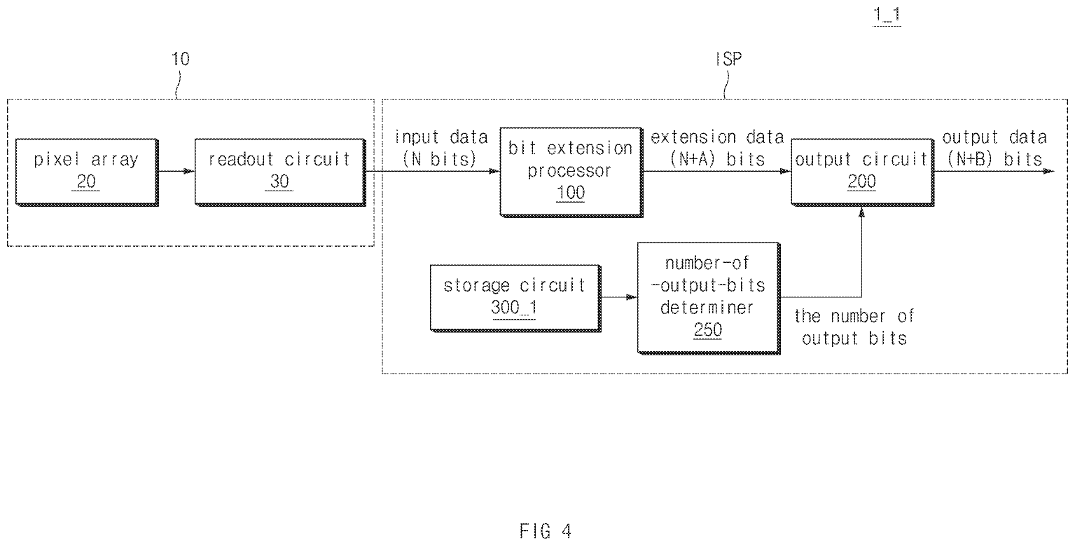

FIG. 4 is a block diagram illustrating an imaging device (1_1) based on another embodiment of the disclosed technology.

Referring to FIG. 4, the imaging device (1_1) may include an image sensing device 10 and an image signal processor ISP. Here, the image signal processor ISP may include a bit extension processor 100, an output circuit 200, a number-of-output-bits determiner 250, and a storage circuit 300_1.

Differently from the image signal processor ISP of FIG. 1, the image signal processor ISP shown in FIG. 4 may further include the number-of-output-bits determiner 250 located between the storage circuit 300_1 and the output circuit 200, but the remaining constituent elements other than the number-of-output-bits determiner 250 of FIG. 4 are identical to those of FIG. 1. Therefore, in FIG. 4, the same elements as those of FIG. 1 are denoted by the same reference numerals, and as such a redundant description thereof will herein be omitted.

The storage circuit 300_1 may include a register. The image signal processor ISP may store a register value for calculating the amount of noise from the gain value of the pixel data in the storage circuit 300_1. Here, the register value may include a parameter (k) related to the amount of shot noise as shown in Equation 3, a noise variance value (V₀) or the like during light blocking as shown in Equation 6 below.

The number-of-output-bits determiner 250 may adjust the bit value of the output data to be output through the output circuit 200 based on the register value stored in the storage circuit 300_1. According to the embodiment of FIG. 4, the number-of-output-bits determiner 250 may determine whether to extend the bit value of the output data to be output through the output circuit 200. For example, the number-of-output-bits determiner 250 may calculate the number of output bits by calculating a noise standard deviation based on the register value stored in the storage circuit 300_1. In some implementations, the number-of-output-bits determiner 250 may calculate the number of output bits. The calculated number of output bits may be included in the output data as one or two least significant bits (LSBs) of the output data.

The output circuit 200 may adjust the value ‘A’ of extension data having (N+A) bits (e.g., (10+A) bits) to the value ‘B’ (where B may be equal to or less than A) based on the number of output bits determined by the number-of-output-bits determiner 250, and may thus output data having (N+B) bits (e.g., (10+B) bits).

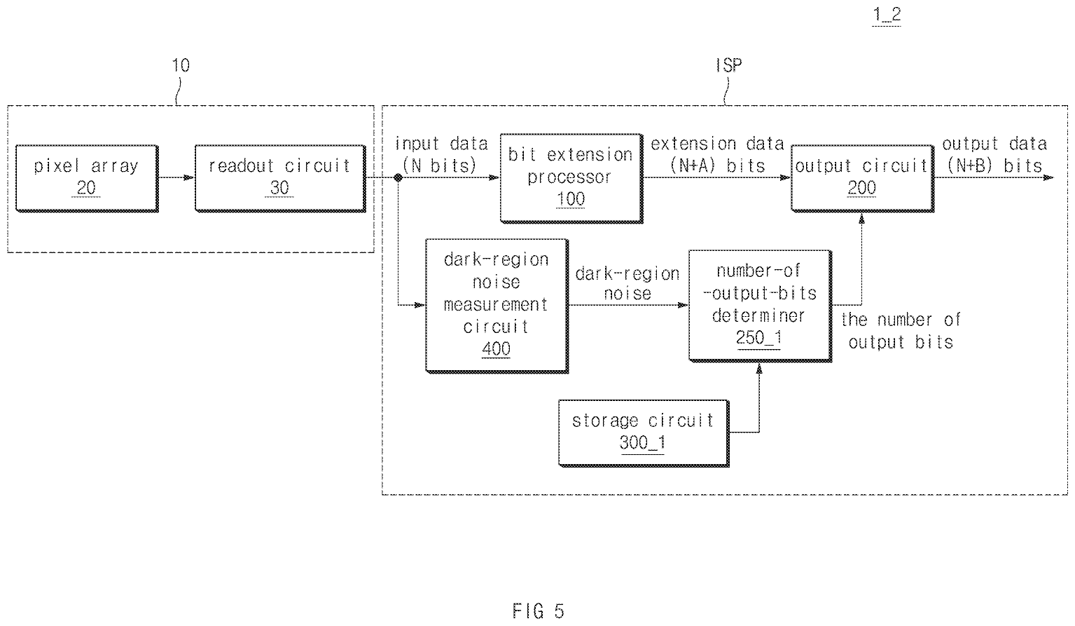

FIG. 5 is a block diagram illustrating an imaging device (1-2) based on still another embodiment of the disclosed technology.

Referring to FIG. 5, the imaging device 1_2 may include an image sensing device 10 and an image signal processor ISP. Here, the image signal processor ISP may include a bit extension processor 100, an output circuit 200, a number-of-output-bits determiner 250_1, a storage circuit 300_1, and a dark-region noise measurement circuit 400.

Differently from the image signal processor ISP of FIG. 4, the image signal processor ISP shown in FIG. 5 may further include a dark-region noise measurement circuit 400, and the number-of-output-bits determiner 250_1 may receive output data of the dark-region noise measurement circuit 400, but the remaining constituent elements other than the circuit 400 and the determiner 250_1 of FIG. 5 are identical to those of FIG. 4. Therefore, in FIG. 5, the same elements as those of FIG. 4 are denoted by the same reference numerals, and as such redundant description thereof will herein be omitted.

The storage circuit 300_1 may include a register. The image signal processor ISP may store a register value for calculating the amount of noise from the gain value of the pixel data in the storage circuit 300_1. Here, the register value may include a parameter (k) related to the amount of shot noise shown in Equation 3.

Noise may occur in the dark region depending on the exposure time or temperature of the image sensing device 10. That is, the pixel array 20 of the image sensing device 10 may include optical black pixels capable of compensating for dark signals of active pixels.

The dark-region noise measurement circuit 400 may measure noise of the dark region of the optical black pixel from among the input data, and may output the measured noise to the number-of-output-bits determiner 250_1. As an example, a noise variance value (V₀) of the dark-region noise can be obtained as represented by Equation 6 below. For example, the dark-region noise calculated by the dark-region noise measurement circuit 400 may represent a noise variance value (V₀) when light is blocked, which will be described with reference to Equation 7 to be described later.

$${V}_{0} = {N}^{- 1} {\sum }_{i} \{ {I}_{i}^{2} \} - {\{ {N}^{- 1} {\sum }_{i} \{ {I}_{i} \} \}}^{2} \qquad [ Equation 6 ]$$

In Equation 6, ‘Iᵢ’ may represent a pixel value, and ‘N’ may represent the number of pixels to be used in variance calculation. Here, ‘I’ may be an index representing the pixel.

The number-of-output-bits determiner 250_1 may adjust a bit value of the output data to be output through the output circuit 200 based on the register value stored in the storage circuit 300_1 and the dark-region noise measured by the dark-region noise measurement circuit 400. That is, the number-of-output-bits determiner 250_1 may adjust a bit value of the output data by considering not only the register value but also the dark-region noise.

In the embodiment of FIG. 5, the number-of-output-bits determiner 250_1 may determine whether to extend the bit value of the output data being output from the output circuit 200. For example, the number-of-output-bits determiner 250_1 may calculate the number of output bits by calculating the noise standard deviation based on the register value and the dark-region noise. In some implementations, the number-of-output-bits determiner 250_1 may calculate the number of output bits. The calculated number of output bits may be included in the output data as one or two least significant bits (LSBs) of the output data.

The output circuit 200 may adjust the A value of extension data having (N+A) bits (e.g., (10+A) bits) to the B value, where B may be equal to or smaller than A, based on the number of output bits decided by the number-of-output-bits determiner 250_1, and may thus output data having (N+B) bits (e.g., (10+B) bits).

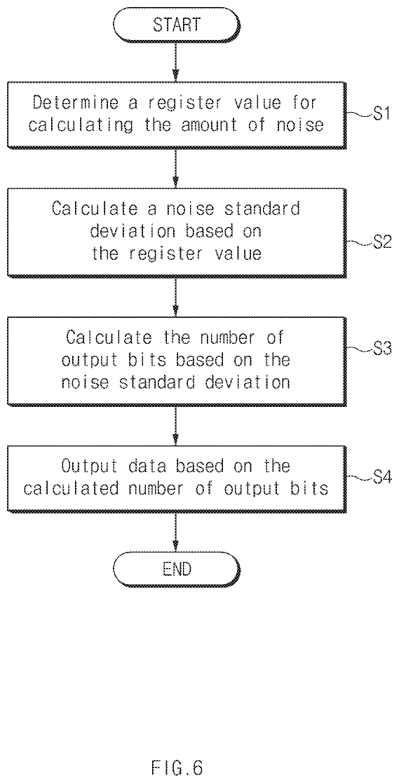

FIG. 6 is a flowchart illustrating an image signal processing method based on still another embodiment of the disclosed technology.

A method for determining the number of output bits of the output data based on some implementations of the disclosed technology will hereinafter be described with reference to FIG. 6. In the following description, a method for adjusting the number of output bits by the number-of-output-bits determiner 250 will be described in detail as an example.

First, a noise variance value V(I,g) of the image sensing device 10 can be modeled as shown in Equation 7 below.

$$V ( I , g ) = k ( g ) ( I - I 0 ) + V 0 ( g ) \qquad [ Equation 7 ]$$

In Equation 7, ‘g’ may represent a gain obtained when image capture (shooting) is performed, a parameter (k) may represent a parameter proportional to the gain (g), and ‘V0(g)’ may represent the noise variance value when light is blocked. In addition, ‘I0’ may represent the pixel value when light is blocked, and ‘I’ may represent the pixel value.

In this way, the image signal processor ISP may preset register values (i.e., the gain ‘G’, the parameter ‘k’, and the value ‘V0’) for calculating the amount of noise, and may store the present register values in the storage circuit 300_1 (Operation S1).

When the standard deviation of the noise increases by 1/R times, the noise variance value VA(I,g) to be obtained after remosaic processing can be calculated as represented by Equation 8 below (Operation S2).

$$V A ( I , g ) = \{ k ( g ) ( I - I 0 ) + V 0 ( g ) \} / {R}^{2} \qquad [ Equation 8 ]$$

As can be seen from Equation 8 above, when the noise variance value VA(I,g) to be obtained after remosaic processing reaches about 1 LSB, tone jump or discoloration may occur in the dark region. Accordingly, the number-of-output-bits determiner 250 may calculate the number of output bits. The calculated number of output bits may be included in the output data as one or two least significant bits (LSBs) of the output data.

The number-of-output-bits determiner 250 based on some implementations of the disclosed technology may calculate the number of output bits based on a value of the gain (G), a value of the parameter (k), and a dark-region noise value generated when light is blocked (Operation S3).

$$V A ( I , g ) = \{ g ( S ) ( I - I 0 ) + V 00 + {g}^{2} V 01 \} / {R}^{2} \qquad [ Equation 9 ]$$

When the parameter (k) is proportional to the gain (g), V0(g) can be modeled as, for example, ‘V00+g²V01’. Then, as shown in Equation 9, the noise variance value VA(I,g) to be obtained after remosaic processing can be estimated from the gain (g) and the pixel value (I).

Here, the pixel value (I) may be set to zero ‘0’ causing minimal variance. In some implementations, the pixel value (I) may also use the value of a pixel having a brightness level at which unexpected problems can be recognized when a gamma curve is applied to a developing process. Therefore, the need for bit extension may vary depending on the shape of the gamma curve or tone curve.

As described above, the output data being output from the output circuit 200 may have (N+B) bits, where B may be equal to or less than A (Operation S4). As a result, the number-of-output-bits determiner 250 may determine the noise variance value VA(I,g). In this case, if it is necessary to extend the number of bits, the number-of-output-bits determiner 250 may set the B value in the same manner as the A value, and may output the resultant value. On the other hand, the number-of-output-bits determiner 250 may determine the noise variance value VA(I,g). In this case, if it is necessary to limit extension of the number of bits of the output data, the number-of-output-bits determiner 250 may set the B value to be less than the A value, and may output the resultant value.

For example, if the noise variance value VA(I,g) becomes smaller than each of 0.25 and 1, it may be determined that extension of the number of bits is necessary. That is, the number-of-output-bits determiner 250 may determine that bit extension is necessary when the gain (g) value is small.

$$B {∼ [ V A ( I , g ) ]}^{- 0.5} \qquad [ Equation 10 ]$$

In Equation 10, the number (B) of extended bits may be determined as represented by Equation 10. Although the embodiment of the disclosed technology has disclosed a method for determining the noise variance value VA(I,g) based on the gain (g) to calculate the number (B) of extended output bits for convenience of description, the scope or spirit of the method for calculating the number (B) of extended output bits based on some implementations of the disclosed technology is not limited thereto, and the method for calculating the number (B) of extended output bits can be sufficiently changed.

As described above, according to the embodiments of the disclosed technology, the optimal number of output bits can be set as one or two least significant bits (LSBs) of the output data. The output bits of the optimal number may represent the standard deviation of noise after remosaic processing. Although the embodiments of the disclosed technology have disclosed the method for setting the number of output bits to one or two LSBs of the output data as the standard deviation of noise for convenience of description, the scope or spirit of the disclosed technology is not limited thereto, and it should be noted that the number of output bits can also be set to another value as necessary.

As an example, the input data is 10 bits and the standard deviation of the noise is 4.0. When the standard deviation of the noise becomes 1/8.0 during the remosaic processing (rather than bit extension), the standard deviation of the noise after the remosaic processing may reach ‘4.0×(1.0/8.0)=0.5’ using 10-bit conversion. In this case, bits can be extended because color tones, etc. occur after remosaic processing.

For example, when the output data is 14 bits by expanding 4 bits from the 10 bits of the input data, the noise standard deviation of the output image can be denoted by ‘0.5×2\hat{ }4=8.0’. That is, in the 14-bit output data of the image, the standard deviation of noise may be represented by 4 LSBs, which is the greater number of output bits than 2 LSBs, and the number of bits of the output data may be excessive. Since the standard deviation of noise is represented by 1 LSB when the output data is 11 bits and is represented by 2 LSBs when the output data is 12 bits, it can be seen that the optimal number of bits of the output data is 11 to 12 bits having one to two LSBs.

As described above, the embodiments of the disclosed technology may investigate (or test and detect) the amount of noise to be generated after remosaic processing (in the dark region) in advance, and may determine the number of output bits as one or two LSBs in the output data, the output bits of the determined number representing the amount of noise.

Here, the amount of noise to be generated after remosaic processing can be estimated from the number of pixels to be referred to when the statistics value (r) required for remosaic processing are processed as in Equation 1 above. According to another embodiment, software for performing an algorithm required for the remosaic processing as floating point numbers is written in advance, so that various images are processed with the software. Finally, the relationship between a noise standard deviation of an input image for each gain setting and a noise standard deviation of an output image for each gain setting can be investigated and calculated.

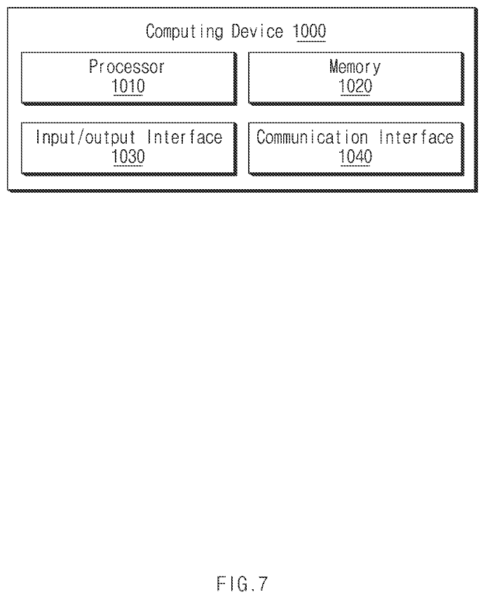

FIG. 7 is a block diagram showing a computing device 1000 corresponding to the imaging device 1 of FIG. 1.

Referring to FIG. 7, the computing device 1000 may represent an embodiment of a hardware configuration for performing the operation of the imaging device 1 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the disclosed technology is not limited thereto.

Additionally, the internal configuration or arrangement of the computing device 1000, the image sensing device 10 and the image signal processor ISP described in FIG. 1 may vary depending on the embodiment. For example, at least a portion of the computing device 1000 may be included in the image sensing device 10. Alternatively, at least a portion of the computing device 1000 may be included in the image sensing device 10. In this case, at least a portion of the computing device 1000 may be mounted together on a chip on which the image sensing device 10 is mounted.

The computing device 1000 may include a processor 1010, a memory 1020, an input/output interface 1030, and a communication interface 1040.

The processor 1010 may process data and/or instructions required to perform the operations of the components (100, 200, 300) of the image signal processor ISP described in FIG. 1. That is, the processor 1010 may refer to the image signal processor ISP, but the scope of the disclosed technology is not limited thereto.

The memory 1020 may store data and/or instructions required to perform operations of the components (100, 200, 300) of the image signal processor ISP, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image signal processor ISP disclosed in the present disclosure is recorded in the memory 1020 and executed and processed by the processor 1010, thereby implementing the operations of the image signal processor ISP.

The input/output interface 1030 is an interface that connects an external input device (e.g., keyboard, mouse, touch panel, etc.) and/or an external output device (e.g., display) to the processor 1010 to allow data to be transmitted and received. The communication interface 1040 is a component that can

transmit and receive various data with an external device (e.g., an application processor, external memory, etc.), and may be a device that supports wired or wireless communication.

As is apparent from the above description, the image signal processor based on some implementations of the disclosed technology can reduce the degree of tone jump and discoloration during remosaic processing of RGBW patterns, thereby improving the quality of image signals.

The embodiments of the disclosed technology may provide a variety of effects capable of being directly or indirectly recognized through the above-mentioned embodiments of the present disclosure.

Although a number of illustrative embodiments have been described, it should be understood that modifications and enhancements to the disclosed embodiments and other embodiments can be devised based on what is described and/or illustrated in the present disclosure. Furthermore, the embodiments may be combined to form additional embodiments.

What is claimed is:

1. An image signal processor comprising:
a bit extension processor configured to generate extension data by expanding, by a first number of bits, a number of bits of input data including a Bayer image and a white image; and
an output circuit configured to adjust, upon receiving the extension data, the first number of bits to a second number of bits to generate output data.

2. The image signal processor according to claim 1, wherein the first number of bits represents a decimal part of the extension data and the bits of the first number is one or more least significant bits (LSBs) of the extension data.

3. The image signal processor according to claim 1, wherein the second number of bits is equal to or less than the first number of bits.

4. The image signal processor according to claim 3, further comprising a storage circuit configured to store the second number of bits as a register value.

5. The image signal processor according to claim 3, wherein the output circuit is further configured to determine the second number of bits based on a gain of the input data.

6. The image signal processor according to claim 1, wherein the bit extension processor is further configured to:
generate the Bayer image and the white image by binning the input data, and
perform a remosaic processing based on the white image to generate the Bayer image, from which a noise has been removed.

7. The image signal processor according to claim 1, wherein the bit extension processor is further configured to determine the first number of bits based on homogeneous color pixels located at specific positions with respect to a target pixel in each of the Bayer image and the white image.

8. The image signal processor according to claim 7, wherein the bit extension processor determines the first number of bits by:
obtaining a statistics value of the homogeneous color pixels according to a similarity index between the target pixel and the homogeneous color pixels, and
calculating the first number of bits based on the statistics value.

9. The image signal processor according to claim 8, wherein the bit extension processor is further configured to:
calculate an estimated value of a noise variance value in response to a parameter related to an amount of shot noise and the noise variance value generated when light is blocked, and
calculate the similarity index based on the estimated value.

10. The image signal processor according to claim 8, wherein the bit extension processor is configured to:
calculate, in response to the statistics value and a weighted average value of white pixels, pixel values of the extension data after a remosaic processing.

11. An image signal processor comprising:
a bit extension processor configured to generate extension data by expanding a number of bits of input data by a first number of bits;
a storage circuit configured to determine, based on a gain of the input data, a register value for calculating an amount of noise;
a number-of-output-bits determiner configured to adjust the first number of bits to a second number of bits based on the register value; and
an output circuit configured to generate output data based on the extension data and the second number of bits.

12. The image signal processor according to claim 11, wherein the storage circuit determines the register value further based on a parameter related to an amount of shot noise, and a noise variance value generated when a light is blocked.

13. The image signal processor according to claim 11, wherein the input data includes a Bayer image and a white image.

14. The image signal processor according to claim 11, wherein the second number of bits is equal to or less than the first number of bits.

15. The image signal processor according to claim 11, wherein the number-of-output-bits determiner is further configured to determine the second number of bits by calculating, based on the register value, a noise standard deviation.

16. The image signal processor according to claim 15,
wherein the number-of-output-bits determiner determines the second number of bits based on the noise standard deviation, and
wherein the second number of bits represents a decimal part of the output data and the bits of the second number are included in the output data as one or two least significant bits (LSBs) of the output data.

17. An image signal processor comprising:
a bit extension processor configured to generate extension data by expanding a number of bits of input data;
a storage circuit configured to determine, based on a gain of the input data, a register value for calculating an amount of noise;
a dark-region noise measurement circuit configured to measure a dark-region noise of the input data;
a number-of-output-bits determiner configured to determine a number of output bits based on the register value and the dark-region noise; and
an output circuit configured to receive the extension data and the number of output bits to generate output data having a different number of bits from the extension data.

18. The image signal processor according to claim 17, wherein the number-of-output-bits determiner determines the number of output bits by calculating a noise standard deviation in response to the register value and the dark-region noise.

19. The image signal processor according to claim 17, wherein the input data includes a Bayer image and a white image.

20. The image signal processor according to claim 17, wherein the extension data includes an extended number of bits representing a decimal part and the bits of the extended number are one or more least significant bits (LSBs) of the extension data.
